(19) United States
(12) Patent Application Publication
(10) Pub. No.: US 2006/0193066 A1
(43) Pub. Date: Aug. 31, 2006

(54) Concentrating solar power

(76) Inventor: Melvin L. Prueitt, Los Alamos, NM (US)

Correspondence Address: EDWARDS & ANGELL, LLP, P.O. BOX 55874, BOSTON, MA, 02205, US

(21) Appl. No.: 11/341,628

(22) Filed: Jan. 27, 2006

Related U.S. Application Data
(60) Provisional application No. 60/648,865, filed on Feb. 1, 2005.

(51) Int. Cl. G02B 5/10

(52) U.S. Cl. 359/853

(57) ABSTRACT

A lightweight reflective film formed into one or more frustums of cones with the large diameter of the cones pointed toward the sun concentrate the sun's rays as the rays are reflected through the cone(s) to the narrow end(s). The rays are concentrated onto one or more absorbing surfaces, and the collected energy can be used to heat a fluid that flows in channels within the absorbing body or bodies. The reflective film can be inexpensive plastic. An enclosing lightweight plastic or other flexible material surrounds an assembly of one or more of the cone concentrators, and the entire structure is made rigid by slight interior air pressure and by interior diagonal wires or by lightweight structural members. This system is less expensive than standard parabolic dish solar collectors and is lighter in weight. It requires less precise sun-tracking systems than dish or trough collectors. It can achieve higher temperatures and higher solar collection efficiency than solar troughs.

### CROSS-REFERENCE TO RELATED APPLICATION

This claims priority to and the benefit of Provisional U.S. Patent Application Ser. No. 60/648,865, filed Feb. 1, 2005, the entirety of which is hereby incorporated herein by reference.

### TECHNICAL FIELD

The invention generally relates to concentrating solar power and, more particularly, to concentrating solar power using one or more films to form a collector cone or a collector with multiple conical sections or frustums.

### BACKGROUND INFORMATION

Focusing solar energy to high intensity can provide high temperatures at the target (focal point) in order to drive high-efficiency heat engines. Parabolic trough reflectors have been used effectively in this role. Parabolic dish mirrors can achieve even higher temperatures.

With parabolic trough and dish mirrors, considerable precision is required to construct and maintain them. The mirror facets of a parabolic dish concentrator are fairly expensive to manufacture. Each facet (approximately one square meter) must be mounted on a very rigid structure and must be precisely aligned to keep the sun's image on the target. About once a week, each mirror must be re-aligned. For a 100 square meter dish (1 m² per facet), 100 mirrors must be realigned. Realignment can be done by electronically-controlled actuators, but that requires two motors per mirror facet in addition to sophisticated electronics.

Parabolic dish reflectors have been known to start fires in grass when accidentally pointed in the wrong direction. They can also cause damage to human eyes if the mirror points in a direction that causes sunlight reflection toward a person or if the person looks at the target (focal point).

Some concentrated solar power collectors use plastic films that are inflated and held in place by internal air pressure that is greater than the air pressure outside the inflated collectors. In U.S. Pat. Nos. 3,364,676, 4,033,676, 4,136,123, 4,352,112, and 4,432,342, for example, inflation is used to form and hold the reflecting surfaces in shapes that are or that approximate parabolic surfaces. Some of these designs require a boom to support the target (focus), have expensive support frameworks, require precise focus on the sun, and/or have poor collection efficiency due to the geometry. U.S. Pat. No. 4,267,824 describes a solar concentrator inflated to a cone shape and having a transparent end covering. The inflated shape is supported by its narrow end, and thus wind could blow the inflated shape to the side.

Some other U.S. patents relating to solar power are U.S. Pat. Nos. 4,088,121, 4,612,914, 4,543,945, 4,212,290, 4,744,644, 4,108,158, 3,899,672, 4,161,942, and 4,496,787. Also, see W. P. Teagan's “Review: Status for Markets for Solar Thermal Power Systems” (Arthur D. Little, Acorn Park, Cambridge, Mass., May 2001) which is a document that was prepared for Sandia National Laboratories, and “Direct Solar Reduction of CO to Fuel: First Prototype Results” (Ind. & Eng. Chem. Res., Vol. 41, Number 8, 2002, pp. 1935-1939) by A. J. Traynor and R. J. Jensen.

### SUMMARY OF THE INVENTION

The present invention generally relates to an inexpensive method of producing a high-temperature solar energy collection system and/or device that uses thin flexible reflective films. The term “Suncone” is sometimes used herein to refer to various illustrative embodiments of systems and/or devices according to the invention.

In some embodiments according to the invention, one or more films (typically inexpensive) are formed into cone frustums that reflect and concentrate solar rays as the rays travel from the larger aperture of the collector toward its narrow end. At the narrow end, the lowest frustum of the reflective film(s) can be connected to a metal reflector shaped so that it continues to concentrate the sunrays. These rays are reflected toward an energy absorber (target), which can be coated with a selective coating that readily absorbs the light rays but typically is a poor radiator of infrared energy. A fluid can flow inside the absorber to extract the heat from the absorber. The fluid can then flow away to its point of use. Alternatively, the reflective film can be connected to a metal absorber that is coated with a selective layer to absorb sunlight and heat a working fluid. A plurality of these cone collectors can be used together and housed in a single enclosure unit, and a plurality of such enclosed units (each containing a plurality of the cones) can be used in concert with each other.

The reflective surfaces ideally should be designed so that all or most of the rays from the sun reflect only once before striking the target. For example, if the reflectivity of the cone surface is 0.9 and there is only one reflection before the ray hits the target, then 90% of the energy from the sun will hit the target. With the same reflectivity, if the rays reflect from one part of the cone and then reflect again from another part of the cone, only 81% of the sun's energy will reach the target.

In use, Suncone is pointed toward the sun. Suncone requires less focus precision than a parabolic dish or a parabolic trough in order to concentrate a large portion of the incident sunlight on the target. The reflection method used by Suncone is referred to as non-imaging optics.

The inexpensive film(s) that form(s) each of the reflective cones can be a thin (e.g., 2 mil) aluminized plastic, a thin metal foil, or some other type of thin film that might be treated or otherwise coated. For example, a polyester film (such as “Mylar” which is available from DuPont) that is coated or otherwise treated to place aluminum on one side of the film can be used. Instead of using air pressure inside a film-formed cone to inflate it and maintain its shape, some embodiments according to the invention use slight air pressure (e.g., 0.2 psi) inside an enclosure (such as a cylindrical enclosure) and inside each of the cones (which are located inside the enclosure) to achieve equal or substantially equal air pressure on either side of the cone wall (i.e., both inside and outside the cone) and to form the shape of the enclosure, while mechanical tension also can be used to maintain the cone's shape. Thus, in these embodiments, the conical shape of the cones is maintained by tension on the film(s) that form each of the cones, since air pressure is pushing upward on the top and bottom of the unit. Air pressure maintains the shape of the enclosure, and that shape can be cylindrical. The side wall(s) of the enclosure can be made of a plastic or other thin film material that might be coated or otherwise treated, and it too can be inexpensive. The side wall(s) can be made of the same material used to form the cone(s) but typically will be a different material and a thicker (e.g., 10 to 20 mils) material than the cone material. One or more transparent films can cover the larger-opening end of each of the cones, and can be made of clear plastic. This covering transparent film typically should have a transparency of 96%, a tensile strength of about 30,000 psi, be UV resistant, and capable of tolerating weather for decades. A fluoropolymer resin could be used to form the covering transparent film. For example, one fluorocarbon-based polymer that could be used is ethylene tetrafluoroethylene (ETFE) such as the “Tefzel” ETFE that is available from DuPont.

Alternatively, instead of relying on air pressure to push out on the enclosure to create and maintain the rigidity of the (cylindrical) enclosure, rigid structural members may provide the necessary rigidity and support to keep the flexible cones in tension (from the top and bottom of each cone) and in their conical shape.

In some embodiments of the present invention, a cone formed of the reflective collector film(s) may have two or more cone frustums. That is, as opposed to being a pure cone shape, the collector can be formed of multiple cone sections. In such embodiments, separate cone frustums can be used and rigid rings can be mounted at the junction between each of the cone frustums to provide the multi-cone frustum shape.

In general, the invention, in some illustrative embodiments, involves inexpensive, lightweight, and reflective films formed into one or more cone shapes (where each cone shape can have one or more frustums) with the largest diameter opening of each of the cone shapes pointed toward the sun to concentrate the sun's rays as the rays are reflected through the cone shapes to the narrowest end of the cone shapes. The rays are concentrated onto absorbing bodies, and the collected energy can be used, for example, to heat a fluid that flows in channels within the absorbing bodies. The reflecting films can be inexpensive plastic. An enclosing lightweight plastic or other flexible material (which might be coated or otherwise treated) surrounds an assembly of one or more of the concentrating cone shapes, and the entire structure can be made rigid by slight interior air pressure and possibly also by interior diagonal wires, or by lightweight structural members. This system with its enclosure housing one or more cone shapes is less expensive than standard parabolic dish solar collectors and is lighter in weight. It requires less precise sun-tracking systems than dish or trough collectors. It can achieve higher temperatures and higher solar collection efficiency than solar troughs.

In general, in some embodiments, the invention relates to a solar power concentrator that comprises flexible material (e.g., one or more films) maintained in place and shape by tension and disposed within a housing. The flexible material comprises one or more cone frustums, and the cone frustums together define the shape. In one particular embodiment, the shape includes a single cone frustum. In any event, the shape includes a first end, a first opening at the first end, a second end opposing the first end, a second opening at the second end, and a passage extending through the shape from the first opening to the second opening. The first opening is larger than the second opening. The flexible material also comprises an inner surface facing the passage and an outer surface facing away from the passage, and the inner surface reflects solar energy when solar energy is incident upon the inner surface. The housing, within which the flexible material is disposed, comprises a top, a bottom, and at least one side wall, and the tension is provided by the first end of the shape being coupled to the top and by the second end of the shape being coupled to the bottom. The housing defines interior space between the at least one side wall of the housing and the outer surface of the flexible material, and air pressure in the interior space is equal to or substantially equal to air pressure in the passage. This pressure can be caused by air that is supplied into and maintained in the interior space and the passage. A plurality of these flexible material formed shapes can be disposed together within the housing.

The Suncone design will not start fires in nearby flammable materials. If Suncone is pointed toward the sun, the solar energy target is deep inside the device so that it cannot harm people's eyes, and the bright rays do not strike nearby flammable objects. If Suncone is pointed away from the sun, it does not concentrate the light.

Suncone can produce high temperatures efficiently, so that it can produce high-pressure steam for driving highly efficient heat engines, for example. It is more effective at producing high temperatures than solar trough collectors.

One objective of the invention is to efficiently collect solar energy at high temperature so that high-temperature steam or other fluid may drive highly efficient heat engines.

Another objective of the present invention is to provide a structure for an assembly of conical solar collectors by surrounding the assembly with a film enclosure that is held in place by low air pressure (and possibly also by interior diagonal wires), or by surrounding the assembly with a rigid structure with rigid structural members and guy wires. In either case, the flexible cones are supported and kept in shape by tension and not by inflation.

Another objective of the invention is to provide a solar collector that does not require high precision in tracking the sun.

Another objective of the invention is to provide a solar collector that uses inexpensive materials and inexpensive support structure so that the cost of the collected solar energy is low. Suncone does not require a boom to support the target, and this eliminates the boom cost that is required for solar dishes.

Another object of the present invention is to provide high-temperature solar collectors that can be linked together to a single tracking mechanism for tracking the sun.

Another object of the present invention is to provide a configuration of reflective surfaces so that all or most of the rays from the sun reflect only once before reaching the target.

Another object of the invention is to provide a system that concentrates solar energy onto photovoltaic surfaces.

Other objects, advantages, and features of the invention will become apparent from the following written description to follow, taken in conjunction with the accompanying drawings. The description provides illustrative embodiments according to the invention. Various combinations and changes are contemplated and are part of this disclosure even if not expressly described or otherwise pointed out herein.

### BRIEF DESCRIPTION OF THE DRAWINGS

The accompanying drawings, which are incorporated into and form a part of the specification, illustrate embodiments of the present invention and, together with the description, serve to explain the principles of the invention. The drawings are only for the purpose of illustrating certain embodiments of the invention and are not to be construed as limiting the invention.

FIG. 1A is a cross-sectional side-view schematic of one embodiment of the present invention showing a structure that is held rigid by air pressure.

FIG. 1B is a cross-sectional side-view schematic of one embodiment of the present invention showing a structure that is held rigid by rigid structural members.

FIG. 2 is a top-view schematic of the embodiment shown in FIG. 1A.

FIG. 3 is a cross-sectional side-view schematic of another embodiment of the present invention in which each cone is enclosed in a cylindrical pressurized enclosure.

FIG. 4 is a cross-sectional side-view schematic of another embodiment of the present invention.

FIG. 5 is a top view schematic of the layout of Suncone solar collectors in a field utilizing a sun-tracking control system.

FIG. 6 is a computer graphic illustration showing the connection of sun-tracking control cables attached to a solar power concentrator.

FIG. 7 is a cross-sectional side-view schematic of another embodiment of the present invention.

FIGS. 8 and 9 are cross-sectional side-view schematics of other embodiments of the present invention.

FIG. 10 is a cross-sectional side-view schematic of a simple, short embodiment of the present invention.

FIG. 11 is a cross-sectional side-view schematic illustrating another method of supporting the cone.

FIG. 12 is a schematic of the layout a portion of a row of solar collectors attached to a pipe utilizing a sun-tracking control system.

FIG. 13 is a computer graphic showing the path of sunrays that enter a solar concentrator and reflect from the reflecting walls.

### DESCRIPTION

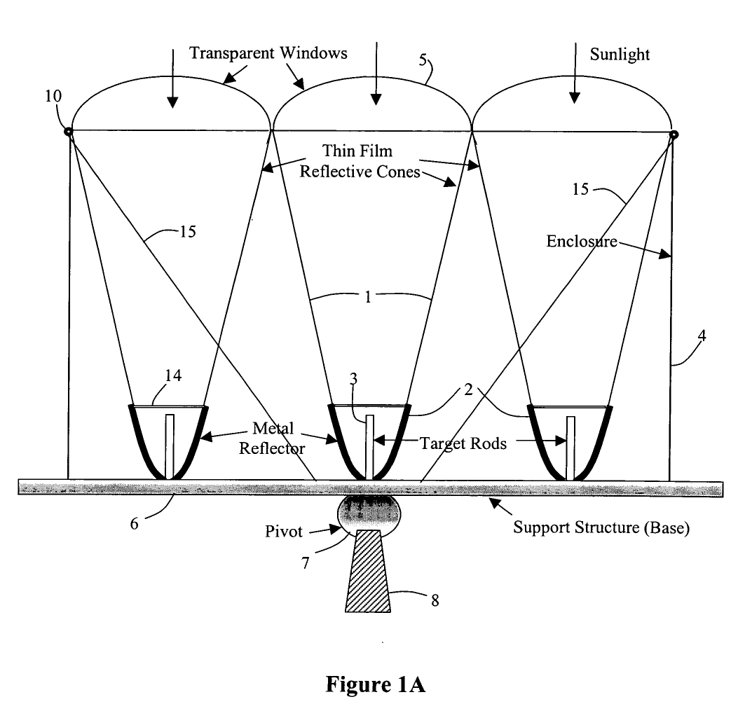

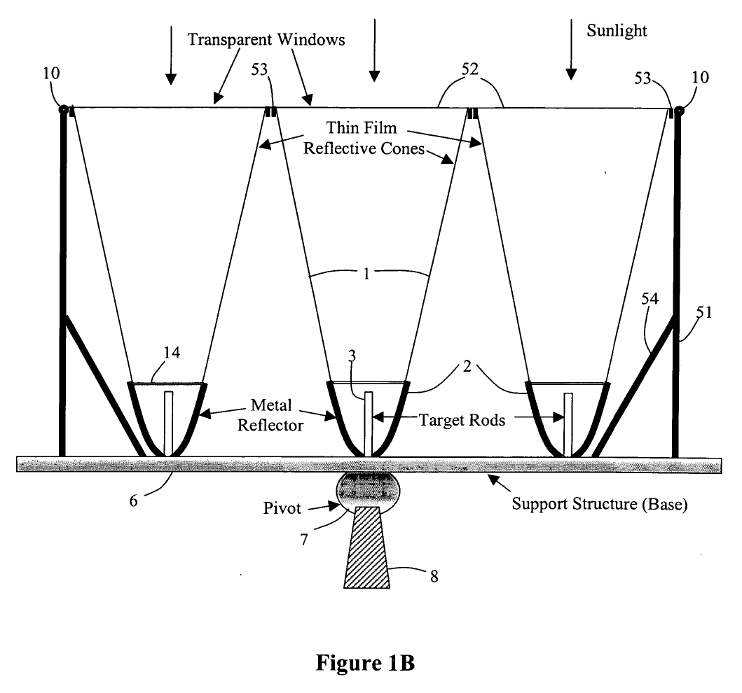

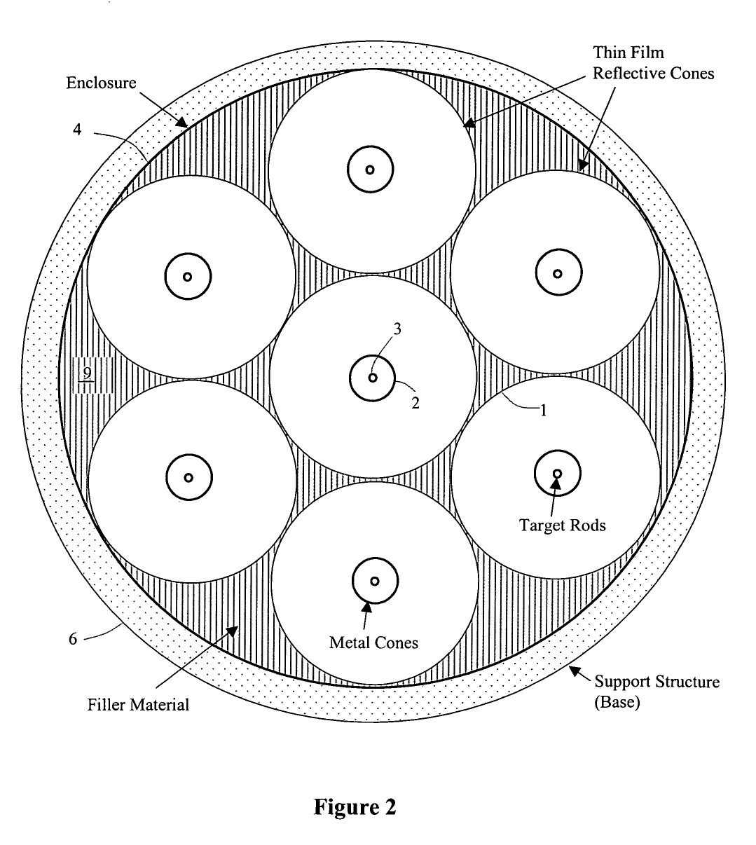

FIG. 1A, a cross-sectional schematic, and FIG. 2, a top-view schematic, illustrate the principles of Suncone and present one illustrative embodiment of the invention. The thin film reflective cones 1 are connected at the bottom to metal reflectors 2. The purpose of the metal reflectors is to withstand the heat in the neighborhood of the target rods 3, which are absorbers of solar energy and are coated with selective absorber material that absorbs solar radiation well but is a poor radiator of infrared radiation. The structure is held rigid by air pressure inside the cylindrical enclosure 4. The enclosure 4 runs from the support structure 6 to a fairly rigid rim 10 that circles the top of the Suncone unit. The top of each cone is covered by a transparent covering 5, which may be thin plastic film or could be flat rigid plastic or glass. Air pressure on the transparent coverings 5 pull upward on the cones 1 to hold the cones in position and keep the cone material in tension. Glass windows 14 decrease convection heat losses that would tend to heat up the air inside the cones. Alternatively, a glass tube could be placed around the target rod 3. To decrease convection heat losses, the space around the target rods 3 should be evacuated.

Interior wires 15 run diagonally from a point on the base 6 to the top of the enclosure 4 and connect to the rigid rim 10. The purpose of the diagonal wires is to improve rigidity. Since air pressure is pushing outward on the enclosure 4 and the interior wires 15 are pulling inward, the structure will be quite rigid. From the drawing, it appears that the wires 15 run through the cones, but when looking at FIG. 2, it can be seen that the wires can be connected to the rigid rim 10 at points that would allow the wires 15 to run between the cones to the base 6.

The shape of the metallic reflectors 2 is defined by a curve of revolution (generatrix) about the axis. The curve can be an exponential curve, but is not necessarily a parabolic curve, since a parabolic curve is defined as one in which the distance from the axis to the curve is proportional to the distance along the axis with an exponent of 2. For the metallic reflectors, the exponent can be different than 2, but the exact value will depend on the geometry of the rest of the system and is optimized by a computer ray-tracing program.

The assembly of FIGS. 1A and 2 sits on the base 6. The base 6 can be lightweight, and it is connected to a pivoting means 7 in this particular illustrative embodiment. The pivot 7 is connected to a support member 8, which is anchored to the ground, to a rooftop, or to some other secure point, surface, or foundation.

Not shown are the connecting pipes that bring the cooling fluid to the target rods 3 and remove the heated fluid. Also not shown are the mechanisms and/or connections needed to inflate the enclosure 4. A small air pump can supply the air. For a field of many Suncone units, a hose from a central pump can supply the air to each unit.

The insides of the cones 1 can be aluminized (or made reflective in some other manner) for high reflectivity. The outer surface of the cones can be coated by flat black, which radiates heat well. Computer simulations show that the cone material remains cool, since the inside reflective layer allows very little solar energy to enter the plastic, but the outside black layer radiates the heat away. The enclosure 4 can be transparent to allow radiation from the cones to pass through the enclosure. Alternatively, the enclosure 4 can be a color (e.g., black) or painted a color (e.g., black) that it will readily absorb radiation from the cones and re-radiate the heat away on the outside. Since the surface of the enclosure ideally is maintained parallel to the sun's rays (as the sun's movement is tracked), it does not get hot from direct sunshine.

The sun's rays ideally are concentrated on the target rods 3, which may have channels inside for the flow of water or other working fluid. Since the rods will get quite hot, they are surrounded by metal reflectors 2. Each plastic cone 1 is attached to the metal reflector 2 with an insulating connector (not shown). The metal reflector 2 and the target rod 3 are attached to the base 6, which is shown as a solid circular and cylindrical disk, but it may be any suitable assembly of one or more structural members. The Suncone structure does not have to be as robust as that of a parabolic dish, since it does not have to be as rigid and since it does not have to support a long metal boom that holds a heavy target at the end. In Suncone, the heat absorption is located adjacent to the base 6.

FIGS. 1A and 2 show schematics of assemblies that have only seven cones. Suncone assemblies may consist of fewer (one or more) or more cones.

For photovoltaic applications, the target rods 3 could be larger in diameter and coated with photovoltaic films. The metal reflector 2 might also be covered with photovoltaic films. The concentration of light would provide higher energy collection per unit area of photovoltaic material. The target rods in this case could have fluid channels within for the collection of useful solar heat.

It should be noted that the target rods 3 are completely shielded from ground observers when the unit is pointed toward the sun, so that eye damage to passersby is impossible. If Suncone is accidentally pointed toward the ground, it will not be pointed toward the sun, so that it cannot start a grass fire. A parabolic reflector, on the other hand, can intercept sunlight even when it is not pointed directly toward the sun, and the reflected light can ignite fires on the ground. Suncone units could be mounted in parking lots above cars to generate electricity for nearby buildings without concern for the safety of people or property below them. They could also be mounted on tops of buildings. Engineers might be reluctant to place parabolic reflectors in such locations.

For high wind conditions, cables or cords extending from the base 6 to the rigid rim 10 can be reeled in to draw the top downward while the air pressure is reduced. The plastic film portion of the unit would be withdrawn into a sturdy cylinder surrounding the lower part of the enclosure to shield against the wind. Even if the plastic materials are destroyed, they are inexpensive to replace.

A small blower or pump provides the slight air pressure that maintains the shape of the plastic films. We can calculate what the stresses are applied to the plastic films of the assembly. Consider a Suncone unit with a total solar collection area of 50 m² in which there are 7 cones that are 2 meters long (including metal reflector length) and 1.5 meter radius at the top. If the internal air pressure is 0.2 psi, the total force on the upper end would be 19,700 lbs. Total radial force on the enclosure film would be 17,500 lbs. If we add diagonal cords or wires internally running from the base 6 to the opposite top rim 10 and spiral cords running around the enclosure, the structure will be quite rigid. For additional rigidity, guy wires can be attached to the top rim and connected to extensions from the base. If the enclosure film is 10 mils thick, the stress on it would be 3,500 psi.

The upward force on each of the transparent windows would be 2,200 lbs. Using 10 mil thick clear plastic film, the stress on the plastic would be only 1,800 psi, which is small compared to its tensile strength. This force is applied to the cones, which transmit the stress to the metal reflector. The highest stress on the cone is at its narrow end. If the metal reflector is one foot in radius, the stress on the 5-mil thick plastic film at the connection point will be 5,800 psi. Metallized Dura-Lar film has a tensile strength of 30,000 psi. (Dura-Lar is an oriented polyester film for general purpose use, and generally is less expensive than DuPont's Mylar.) Of course, some of the stress on the cone can be relieved by having wires run from the base to the top where they could connect to rings that are attached to the top of the cones and to the transparent cover.

These calculations were done to show that it is feasible to construct the rigid structure with lightweight plastic films. If there is concern about the effects of wind on such a light structure, the calculations show that there is almost 30 pounds of force exerted outward on each square foot of surface area. By having interior and circumferential cords or wires that counter the surface forces, the structure will be quite rigid.

FIG. 1B illustrates another embodiment of the present invention in which rigidity of the unit is maintained by rigid structural members. As in the case of FIG. 1A, the conical shape of the flexible film reflectors 1 is maintained by tension from above and below. A circular ring 53 surrounds the top of each cone 1 and is attached to the cone. This keeps the opening of the cone circular. The circular rings 53 are supported by rigid members that are connected to the rigid rim 10, which runs all the way around the top of the Suncone unit. Alternatively, the rigid rings 53 could be supported by rigid support members that run from the base 6 to the rings 53. Rigid rim 10 is supported by rigid members 51. Additional rigidity is supplied by rigid members 54. Alternatively, rigid members 51 could be supported by internal guy wires (like wires 15 in FIG. 1A) and by external guide wires that run from ring 10 to an extension of the base. A plastic enclosure could be wrapped around the unit with cemented contact with the outside of the rigid members 51. This would prevent wind from disturbing the shape of the reflective cones 1. The transparent windows 52 may be flexible or rigid transparent materials.

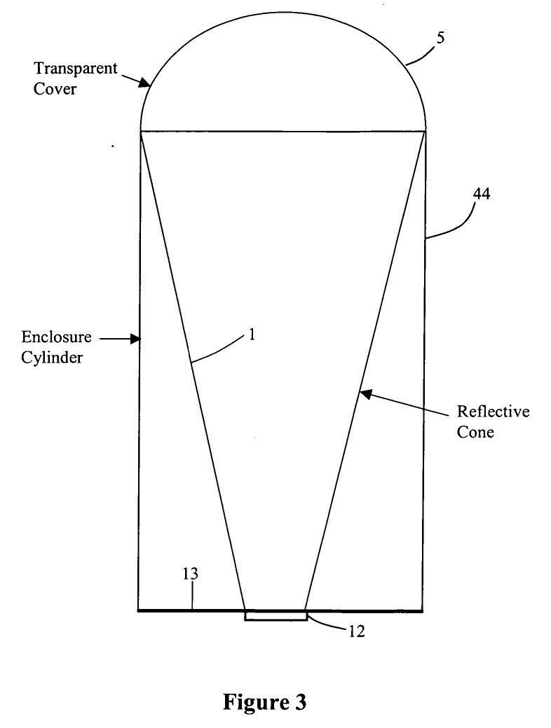

FIG. 3 shows an alternative embodiment of present invention in which each cone 1 is encased in a cylindrical plastic film enclosure 44. Air pressure is supplied to each enclosure, which would ensure that the cone is tight and maintained in its desired shape. (The same or at least substantially the same air pressure is applied and maintained on either side of each cone wall, and it is not inflation that maintains the cones in their shapes but instead tension pulling up on one end of the cone and down on the other end. The cones can have spaces or wholes in them to allow the supplied air pressure to enter the interior of each cone and thereby attain equalized air pressure inside the cone and inside the enclosure.) The enclosure would sustain the force of the air pressure on the transparent window 5, thus eliminating large stress on the narrow end of the cone. Each of these units, incorporating the enclosure, cone, transparent window, and base sheet could be manufactured in a factory and assembled onto the base in the field. The metallic connector 12 is designed to connect to the top of the metal reflectors 2 in FIG. 1A. It incorporates insulation to prevent the heat of the metal reflectors 2 from heating up the cones 1. The film enclosure 44 is connected to a rigid sheet 13 at the lower end of the assembly. After each unit is installed, it can be attached to adjacent units by adhesive or Velcro. An additional enclosure film could be wrapped around the entire assembly. External and internal tether cords or cables (guy wires) will maintain structural stability. Alternatively, instead of the pressurized enclosure 44, the rigidity of the assembly could be provided by rigid structural members as is described for FIG. 1B.

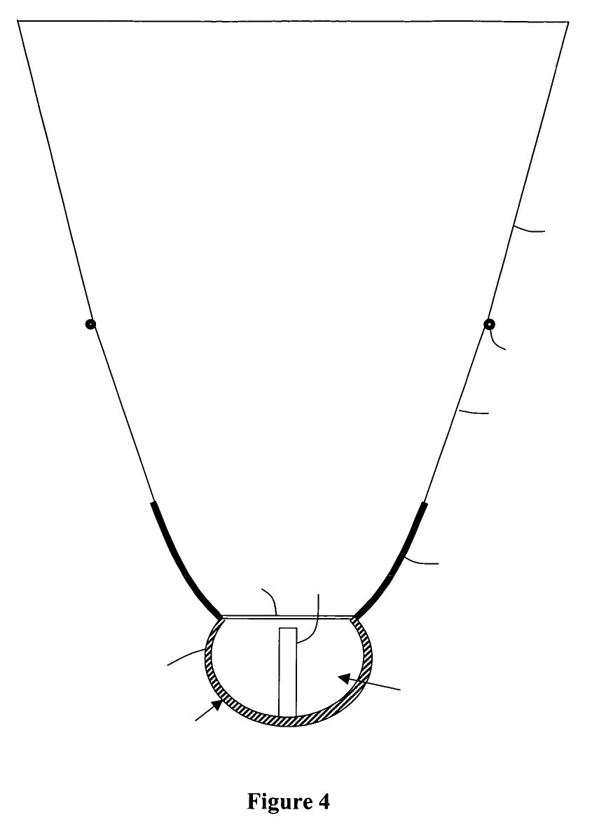

FIG. 4 is an embodiment one of the “cones” (which are to be placed on the base support structure 6) of the present invention in which the sunrays are reflected into a hohlraum cavity 25, wherein the target rod 3 is placed. The interior walls of the hohlraum chamber 24 are coated with a light-absorbing material. It absorbs solar energy and becomes hot. The cooling fluid that flows through the target rod 3 can also flow through channels in the hohlraum chamber 24 walls to be heated. Alternatively, the fluid can flow through pipes (not shown) that are welded to the outside of the hohlraum chamber 24. A hohlraum chamber tends to trap radiant heat. Radiation from the wall on one side is often radiated to the opposite wall or to the target rod. Likewise, much radiation from the target rod flows to the chamber walls. Insulation (not shown) on the outside of the chamber 24 prevents loss of heat.

The advantage of this embodiment is that it is quite insensitive to the accuracy of a tracking mechanism that points the device toward the sun. In this design, the cone is divided into two reflective film cone frustums 20 and 21 in order to more closely match an exponential generatrix for the collector shape. A circumferential rigid ring 22 holds the reflective films 20 and 21 in place. The top of reflective film 20 is held in place by air pressure on the transparent cover (not shown, but like 5 in FIG. 1A). The bottom of reflective film 21 is connected to metal reflector 2, whose shape is defined by an exponential generatrix. Reflected sunlight passes through a glass window 26, which has the purpose of reducing convective heat losses. The cavity 25 can be evacuated for further reduction in heat losses.

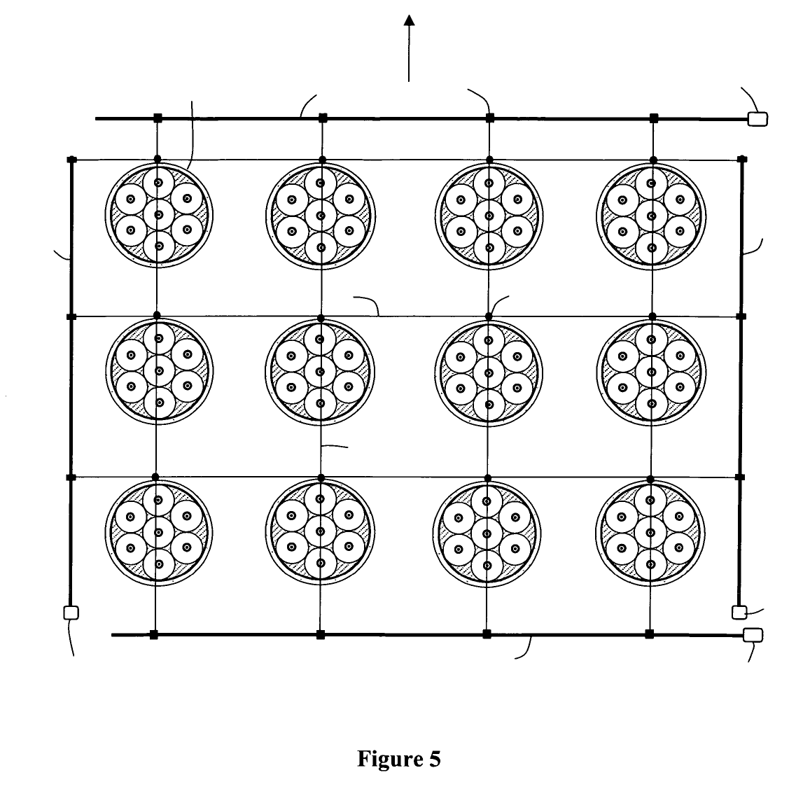

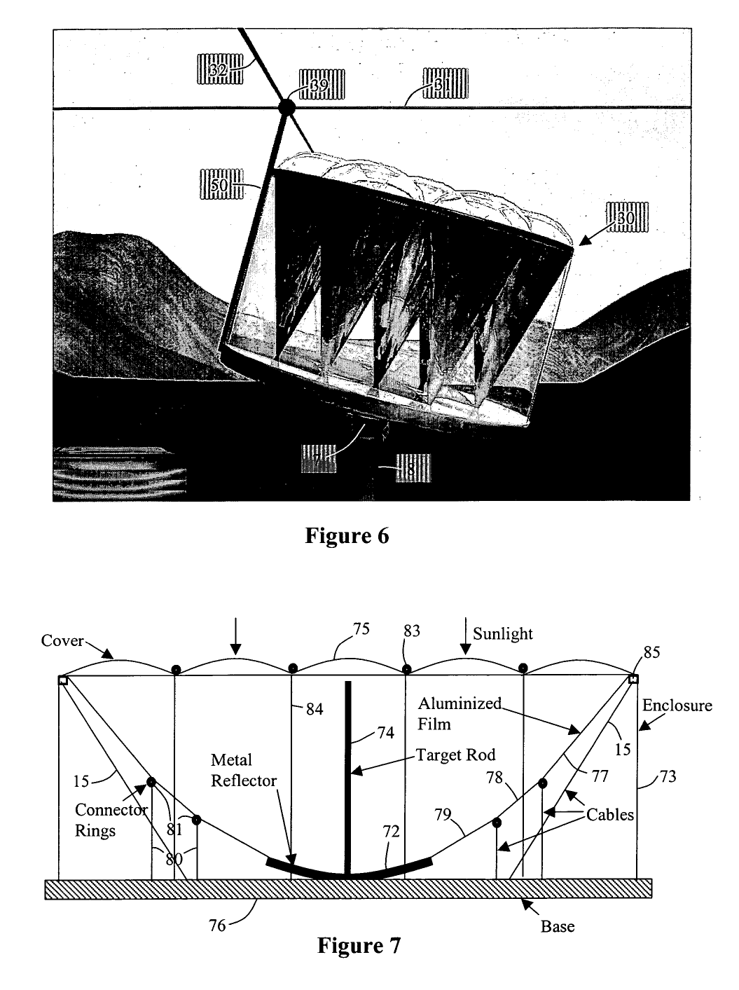

FIG. 5 shows a top view of a possible layout of Suncone units 30 on a field. Since Suncone solar collectors do not have to be pointed toward the sun as accurately as solar dishes or troughs do, this system is adequate to provide sun-tracking for all units on the field. Each unit 30 is pivoted on the bottom so that it can point toward the sun as the sun traverses the sky from east to west each day and as it changes north-to-south angles during the year. A control system (not shown) actuates motors 34, 35, 36, and 37 to rotate rods 40, 41, 42, and 43, respectively. As the rods rotate, they cause winches 33 to rotate in order to draw in or let out cables 31, which run north-south, and cables 32, which run east-west. The north-south cables 31 are attached to connectors 39 on the north sides (in the Northern Hemisphere) of the Suncone units 30. The east-west cables 32 are also attached to connectors 39 on the north sides of units 30. The connectors 39 are attached to the top of rods (50 in FIG. 6), which are attached to units 30. As cables 32 are drawn onto winches 33 on rod 43, the Suncone units 30 are tilted toward the west. When cables 32 are pulled to the east by winches 33 on rod 42, units 30 are tilted toward the east. Likewise cables 31 can tilt units 30 north or south by being drawn onto winches on rods 40 or 41 respectively.

Since the arrangement of connectors 39, rod 50, and cables 31 and 32 are difficult to present in a two-dimensional drawing, FIG. 6 shows a computer artist's illustration of the assembly. In the lower latitudes of the Northern Hemisphere, the Suncone solar collectors would be generally tilted toward the south, in addition to swinging from east to west. Thus, the rod 50 is attached to the north side of each Suncone unit 30. Cables 31 and 32 are attached to connector 39, which is pivotally attached to the top of rod 50. Cable-length adjustment means are mounted on the cables between Suncone units so that adjustments may be made in the pointing direction of each Suncone unit.

Pivot 7 is designed to constrain the orientation of each Suncone unit so that rod 50 is always directly on the north side of the unit, but it allows the Suncone unit to tilt toward the sun. In the Southern Hemisphere, rod 50 would be on the south side of the Suncone unit.

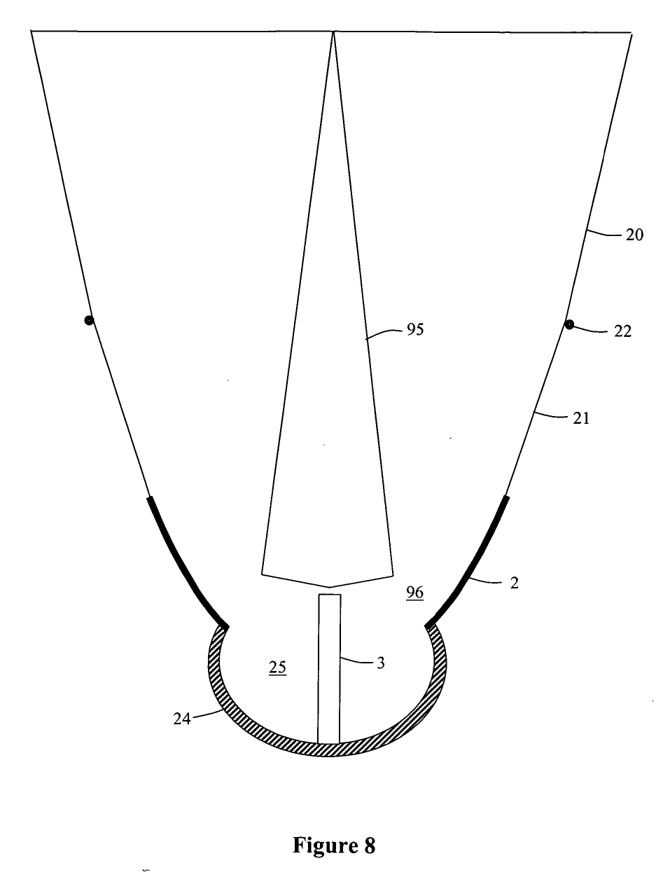

If it is desirable to have a short structure with large solar collection area, the embodiment of one of the “cones” shown schematically in FIG. 7 can be constructed with plastic film cone frustums that approximate an exponential generatrix. The different segments of aluminized film 77, 78, and 79 are actually regular cone frustums, so that they can be constructed of flat plastic film. The segments are connected together at the connector rings 81, which are pulled downward by cables or cords 80 to keep tension on the film segments. The shape of the cone frustums is maintained by tension on the films. A paraboloidal metal reflector 72 is placed adjacent to the hot target rod 74. Enclosure 73 and cover 75 are connected to ring 85, which circles around the top. Cone frustum 77 is also connected to ring 85. The enclosure 73 can be made of thin film and can supply rigidity to the structure by slight air pressure within the unit and by interior diagonal wires 15. In order to sustain the pressure, the cover 75 require periodic rings 83 on top and cables 84 attached to the rings, which cables run down to the base.

Alternatively, the rigidity of the structure can be maintained by rigid structural members as was described for FIG. 1B. Again, the shape of the cone frustums is maintained by tension on the cones.

With this design, a single reflector unit with 100-m² solar collection area can be constructed that has a diameter of 11.3 meters and a height of 4 meters (from base to the cover). Computer simulations calculated its solar collection efficiency to be 70%, which is a less than that of the other embodiments, but it has a single target rod for heat absorption. The target rod can be surrounded by a glass tube, which is evacuated to reduce heat loss. One problem with this design is that it requires greater sun-tracking precision than the other designs.

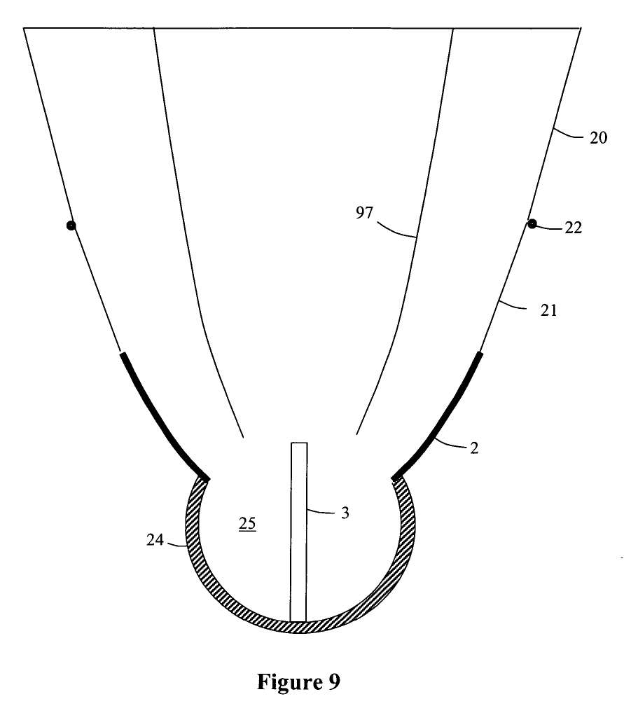

FIG. 8 is a schematic representation of another embodiment of one of the “cones” (which are to be placed on the base structural support) of the present invention. It is similar to the embodiment in FIG. 4, but it contains a central conical structure 95. The main advantage to this design is that it is quite insensitive to the accuracy of the sun-tracking mechanism. Sunlight reflected from cone 95, cone frustums 20 and 21, and metal reflector 2 enter the hohlraum cavity 25 through an annular opening 96. The target rod 3 and hohlraum chamber interior wall 24 is coated with light-absorbing material. Useful heat is removed form the target rod 3 by fluid flowing within one or more internal fluid flow passages or channels within the target rod 3. Heat is removed from the chamber wall 24 by fluid-carrying pipes (not shown) connected to the outer or inner wall. Cone frustums 20 and 21 may be constructed of aluminized plastic films that are painted black on the outside. The black surface is a good radiator of heat, so that the plastic does not get hot. Cone 95 must be constructed of a metal or other high melting point material, since its outside reflector is a poor radiator of heat, and radiation from the inside surfaces is trapped. Thus Cone 95 can get hot.

FIG. 9 is a schematic representation of another embodiment of one of the “cones” of the present invention. It is similar to that of FIG. 8, but the central conical reflector is replaced by a thin metal reflector 97 that has an exponential generatrix surface. This embodiment is a high efficiency solar collector and is quite insensitive to sun-tracker inaccuracies.

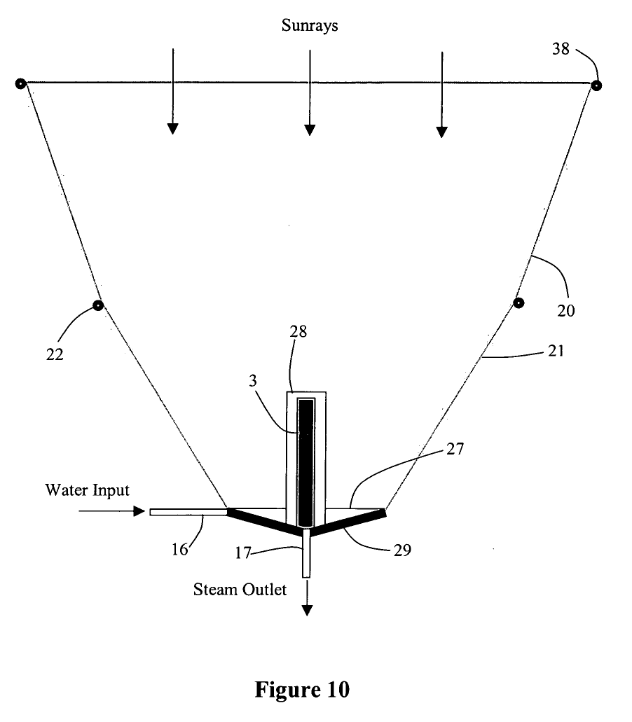

FIG. 10 is a schematic representation of a short and simple embodiment of one of the “cones” of the present invention. Having it shorter makes it possible to have a completed Suncone unit that is shorter, requires less reflector material, and provides reflected sunrays from the cones that are nearer to being normal to the rod surface than rays from longer cones. If the rays are far from normal, excessive reflection from the glass tube (that surrounds the rod) occurs. Cone frustums 20 and 21, which are supported by rigid rings 22 and 38 and absorber 29, reflect sunlight toward the target rod 3. Some of the rays impinge upon absorber 29, which delivers the heat to water that flows through absorber 29 or to water that flows through pipe 16 that is welded to absorber 29. The heated water then flows into the target rod 3 to be boiled and superheated and then flows out pipe 17. Glass envelope 28 reduces convective heat loss. Glass sheet 27 also reduces convective heat loss.

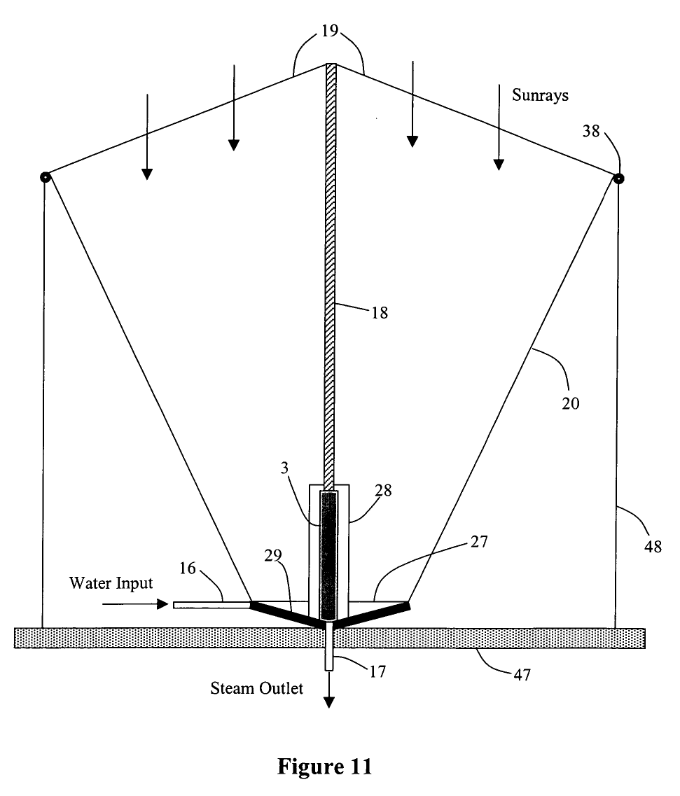

FIG. 11 is a schematic representation of another method of supporting the cone reflector by tension. Rod 18 is rigidly attached to target rod 3 and extends above the opening of the cone 20. In this figure, only one cone frustum is shown. Transparent film material 19 forms a window above the cone and transmits upward force from the rod 18 to rigid ring 38. Tension is maintained in cone 20 by its connection to rigid rod 38 and its connection to absorber 29. Absorber 29 is attached to support base 47. If the solar collector consists of a single cone, enclosure 48, which can be thin film material, prevents wind from disturbing the cone. If the solar collector consists of a number of cones (as in FIG. 1), enclosure 48 is not necessary, and an enclosure may surround the entire assembly, and the base 47 would be common to all the cones (as support structure 6 in FIG. 1). Alternatively, window 19 could be flat rigid plastic or glass that would extend across the cone opening and connect to rigid ring 38. In this case, the rod 18 would be shorter. Other parts of this embodiment are described in the description for FIG. 10.

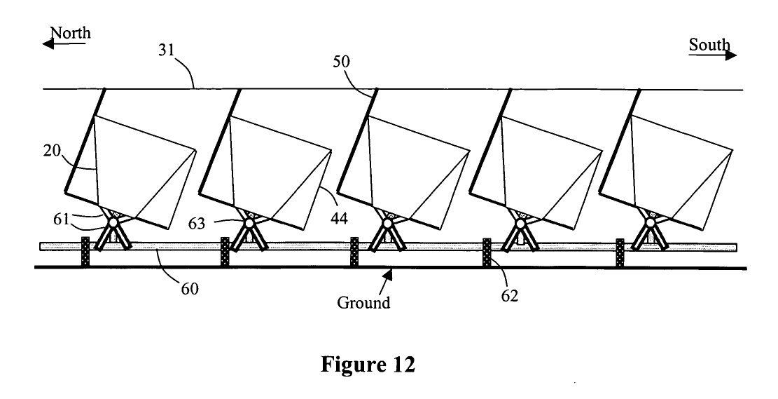

FIG. 12 is a schematic of the layout a portion of a row of solar collectors attached to a pipe utilizing a sun-tracking control system. FIG. 12 illustrates an embodiment of the present invention in which individual cone assemblies are attached to a mounting structure 60. The mounting structure may be a pipe. The individual cone assemblies similar to those shown in FIG. 3 with reflective cones 20 and inflatable enclosures 44 or rigid framework similar to that of FIG. 1B are attached to the pipe 60. Support members 61 are connected together by pivots 63 and are connected to the cone solar collector assembly and to the pipe 60. The pipe is supported by supports 62 that are anchored to the ground. The pipe 60 is able to rotate. The pipe 60, in addition to being a support, conducts working fluid to and from the target rods in the solar collectors. Tracking cable 31 pulls the rods 50 north or south to point the collectors toward the sun for variation of the seasons. Other cables, which are not shown, but are approximately perpendicular to the page, pull the collectors east or west to follow the sun during each day. This is similar to the cable functions in FIG. 5 except that in FIG. 12 each rod 50 is connected to a single-cone collector rather than a multi-cone collector. As the collectors rotate from east to west, the pipe 60 rotates with them.

Partitions inside the pipe 60 divert cool working fluid into the collector target rod and accept heated fluid back into the pipe, to be heated further by the next collector along the pipe 60.

FIG. 12 represents only part of one row of solar collectors. Other rows adjacent to the partial row shown in FIG. 12 could be placed in the field in a manner similar to FIG. 5. A single tracking mechanism can point a whole field of solar collectors toward the sun.

COMPUTER SIMULATIONS: Since it is difficult to determine which reflecting surface geometries will be efficient solar collectors and will be insensitive to sun-tracking accuracy just by examining a drawing, a ray-tracing program called SUNCONE.F was written to simulate the performance of solar concentrators. Several thousand rays per second (of simulated time) are traced from random locations on the sun to random locations at the mouth of the cone. From there, each ray is traced to an intersection with the cone frustums, metal reflector, or rod. At each intersection, part of the ray is reflected, and the rest of the energy is absorbed into the surface. The amount of energy that is reflected and absorbed depends on the reflection coefficient. The ray continues on through multiple reflections until it exits the system. This method is extremely accurate in determining the performance of reflectors and absorbers of various geometries, if the emissivities and reflectivities are properly defined. The surface is assumed to be smooth.

After all the sunrays are traced for a one-second duration, radiation from the film reflectors, metal reflector, and rod (and hohlraum cavity, if present) are simulated. The components are divided into numerical cells. Since each cell receives energy during the sunray simulation, some of that energy is used to heat the cell, and the rest is radiated according to the equation,
P=eAσT⁴
where P is the radiation power, e is the emissivity, A is the area, a is 5.6699×10⁻⁸ in SI units, and T is the absolute temperature in degrees K. The solution of the problem of how much of the energy is used for heating the material and how much is radiated is determined by iteration. The radiated energy for the one-second time interval is emitted from each cell by random rays, which are then followed through multiple reflections. These rays also impart energy to the different component cells. After rays have been emitted from all the cells, we note that the cells now have received more energy, due to the radiation from all the cells. That is, the cells lose energy by emitting radiation but gain energy by radiation from other cells. Thus the process must be repeated in order to determine the balance between radiated and received energy.

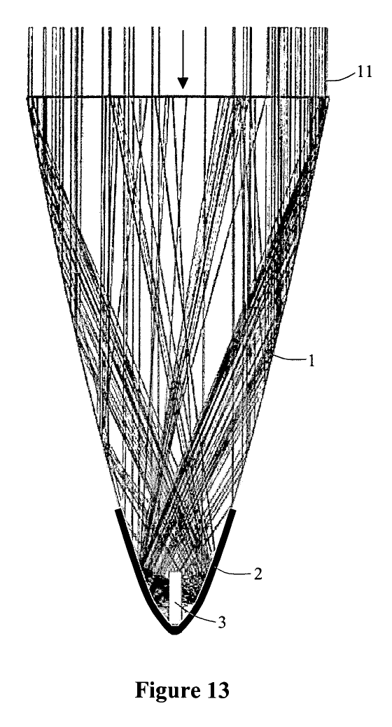

FIG. 13 shows computed rays 11 from the sun entering the top of the cone. The rays are reflected from the cone 1 and from the metal reflector 2 and are concentrated on target rod 3. After partial absorption of energy into the target rod 3, the rays are reflected back to the reflecting walls and back out the top aperture. These exiting rays are shown as terminated at the aperture, in order to distinguish them from the incoming rays from the sun. For clarity, the rays in the plot are shown in the plane of the paper. In a simulation for real performance, the geometry is three-dimensional, and the rays move in all directions in the cone.

SUNCONE.F was used to simulate the performance of existing parabolic dish collectors, and the results of the computer runs were within 5% of the experimental values.

For standard parabolic dish solar collectors, which consist of many mirror facets, the mirrors must be aligned precisely. In the case of a 100-m² dish with a 13-meter boom on which there is a 22 cm diameter target, if the dish is misaligned by 1 a degree, the target will receive only 39% of the power. If it is misaligned by 1 degree, it will receive no power at all. For some designs of Suncone, if the alignment is 1 degree off, it will still absorb 94% of the sunlight that it would absorb for perfect alignment. Even at 5-degree misalignment, it will still receive over 80% of the power that it would receive at perfect alignment. Since Suncone collectors do not require high sun-tracking precision, systems like that shown in FIG. 5 are made possible. For prior art parabolic dish collectors, each dish must have its own tracking system, and each mirror facet must be periodically adjusted.

The cones in Suncone do not have to be precisely constructed. Minor flaws are insignificant. Computer simulations were run with SUNCONE.F in which numerous perturbations (up to a half-centimeter in size) were applied to the cone surface randomly. The energy reaching the target rod was still above 90% of what a perfect cone would provide. The mirror facets on a parabolic mirror must be precise.

Large hailstones can damage glass mirrors. With Suncone, the tough plastic films, supported by slight air pressure, will yield when struck by hailstones and bounce back to their former geometry.

The invention is not to be limited only to the illustrative embodiments shown and described herein. Various changes are possible and will occur to those of ordinary skill without departing from the spirit or scope of the invention. Various combinations not specifically shown or described herein also are possible and are to be considered part of this disclosure.

What is claimed is:

1. A solar power concentrator, comprising:
flexible material maintained in place and shape by tension, the flexible material comprising one or more cone frustums, each of the cone frustums together defining the shape, the shape including a first end, a first opening at the first end, a second end opposing the first end, a second opening at the second end, and a passage extending through the shape from the first opening to the second opening, the first opening being larger than the second opening, the flexible material comprising an inner surface facing the passage and an outer surface facing away from the passage, the inner surface reflecting solar energy when solar energy is incident upon the inner surface; and
a housing within which the flexible material is disposed, the housing comprising a top, a bottom, and at least one side wall, the tension provided by the first end of the shape being coupled to the top and by the second end of the shape being coupled to the bottom, the housing defining interior space between the at least one side wall of the housing and the outer surface of the flexible material, air pressure in the interior space being equal or substantially equal to air pressure in the passage.

2. The solar power concentrator of claim 1 wherein the inner surface of the flexible material includes a reflective coating.

3. The solar power concentrator of claim 1 wherein the inner surface of the flexible material is aluminized.

4. The solar power concentrator of claim 1 wherein the flexible material comprises a single one of the cone frustums.

5. The solar power concentrator of claim 1 wherein the flexible material comprises a plastic film.

6. The solar power concentrator of claim 1 wherein the flexible material comprises foil.

7. The solar power concentrator of claim 1 wherein the flexible material comprises a polyester film.

8. The solar power concentrator of claim 1 wherein the at least one side wall of the housing comprises flexible material.

9. The solar power concentrator of claim 8 wherein the flexible material of the housing is different than the flexible material disposed within the housing.

10. The solar power concentrator of claim 8 wherein the flexible material of the housing comprises a fluorocarbon-based polymer film.

11. The solar power concentrator of claim 10 wherein the fluorocarbon-based polymer film comprises ethylene tetrafluoroethylene.

12. The solar power concentrator of claim 1 wherein the first end of the shape is indirectly connected to the top.

13. The solar power concentrator of claim 1 wherein the first end of the shape is directly connected to the top.

14. The solar power concentrator of claim 1 wherein the second end of the shape is indirectly connected to the bottom.

15. The solar power concentrator of claim 1 wherein the second end of the shape is directly connected to the bottom.

16. The solar power concentrator of claim 1 wherein the housing comprises a cylindrical shape.

17. The solar power concentrator of claim 8 wherein the air pressure in the interior space and the air pressure in the passage is created by air supplied to and maintained in the interior space and the passage.

18. The solar power concentrator of claim 1 wherein the housing comprises a rigid structure.

19. The solar power concentrator of claim 1 further comprising a plurality of the shapes, each of which is maintained by tension and is disposed within the housing.

20. The solar power concentrator of claim 1 wherein the flexible material comprises a film.

21. A solar power concentrator comprising:
lightweight cones with reflective inside surfaces and black outside surfaces for accepting sunrays at conical wide ends and for concentrating the sunrays by reflection to conical narrow ends and for radiating away heat from said lightweight cones by having said black outside surfaces;
metal reflectors, with shapes defined by an exponential generatrix, attached to the narrow ends of said lightweight cones;
transparent windows attached to the wide ends of said lightweight cones;
target rods coated with a solar-energy-absorbing coating centered inside said metal reflectors;
fluid passages within said target rods for removing heat from said target rods;
insulating windows attached to and covering said metal reflectors for the purpose of decreasing convective heat loss from said target rods;
a base structure to which said metal reflectors and said target rods are attached;
a cylindrical enclosure attached to the outer periphery of said base structure for maintaining slight air pressure within said solar power concentrator;
diagonal wires connected to said base structure and connected to the top periphery of said cylindrical enclosure;
a pivot means for rotateably supporting said base structure; and
a support means for supporting said pivot means above the ground or other foundation;
wherein said cylindrical enclosure provides rigidity to said solar power concentrator due to interior air pressure and to said diagonal wires, and wherein said transparent windows apply tension to said lightweight cones due to interior air pressure to maintain the shape of said cones, and wherein sunlight is concentrated by reflection from surfaces of said cones and said metal reflectors onto said target rods to make said target rods hot, and wherein a cooling fluid flows through said fluid passages within said target rods to remove the heat from said target rods.

22. The solar power concentrator according to claim 21 further comprising:
a second cylindrical enclosure for enclosing each said lightweight cone;
a rigid sheet attached to one end of said second cylindrical enclosure to seal against air leakage and to provide support for said second cylindrical enclosure and for said lightweight cone; and
a metallic connector attached to the narrow end of said lightweight cone for the purpose of facilitating attachment to said metal reflector;
wherein said second cylindrical enclosure is attached to the wide end of said lightweight cone and to said transparent window to provide rigidity due to interior air pressure and to maintain the shape of said lightweight cone.

23. A solar power concentrator, comprising:
a solar concentrator comprising two or more cone frustums for approximating concentrator surfaces defined by exponential generatrices;
one or more rigid rings for joining said cone frustums and for holding the ends of said cone frustums in circular geometry;
a said metal reflector connected to the narrow end of the narrowest said cone frustum;
a hohlraum chamber attached to the narrow end of said metal reflector for enclosing a hohlraum cavity for receiving concentrated sunlight and for enclosing said target rod; and
an insulating window covering the opening of said hohlraum chamber for reduction of convective heat losses;
wherein sunlight is concentrated by the said cone frustums and said metal reflector into the hohlraum cavity, and wherein solar energy is absorbed into said target rod and into said hohlraum chamber walls, and wherein useful heat is removed by fluid flowing within said fluid channels in said target rod and by fluid flowing in second fluid channels in the walls of said hohlraum chamber or attached to the inside or outside of said hohlraum chamber.

24. A solar power concentrator, comprising:
a set of cone frustums and a metal reflector with a low-profile geometry to approximate an exponential generatrix;
one or more rigid rings for joining said cone frustums and for holding the ends of said cone frustums in circular geometry;
cables connected to said rigid rings and to a base structure to maintain positions of cone frustums;
said metal reflector connected to the narrow end of the narrowest said cone frustum;
an elongated target rod for the collection of solar energy;
a cylindrical enclosure for maintaining structural rigidity by containing air pressure;
said base structure on which components are mounted;
a large-diameter rigid ring to hold the wide end of the largest cone frustum, connected to the top of said cylindrical enclosure;
a transparent cover to seal in the air pressure and prevent dust from reaching interior surfaces;
one or more second rigid rings placed on top of said transparent cover to hold said transparent cover in place; and
second cables connected to said second rigid rings and to said base structure to hold said second rigid rings in place;
wherein sunlight is concentrated by said cone frustums and said metal reflector onto said target rod, and wherein the geometry is maintained by slight air pressure on said cylindrical enclosure and said transparent cover.

25. The solar power concentrator according to claim 23 further comprising a central reflective cone with the sharp point of said central reflective cone pointing toward the sun for concentrating solar energy into an annular opening into said hohlraum cavity.

26. The solar power concentrator according to claim 23 further comprising an interior sheet material, which is reflective on both surfaces, with shape defined by an exponential generatrix with the wide end facing the sun for concentrating solar energy into an annular opening into said hohlraum cavity.

27. A sun-tracking system for pointing an array of solar power concentrators comprising:
a set of east-west cables, with each cable coupled to a row of said solar power concentrators that are aligned east to west;
a set of north-south cables, with each cable coupled to a column of said solar power concentrators that are aligned north to south;
east and west rotateable rods to which winches are coupled for pulling said east-west cables to the east or west to cause said solar power concentrators to rotate to the east or west, respectively, to point toward the sun;
north and south rotateable rods to which winches are coupled for pulling said north-south cables to the north or south to cause said solar power concentrators to rotate to the north or south, respectively, to point toward the sun; and
one or more motors to drive said rotateable rods and an electronic control system to control said one or more motors;
wherein said east-west cables and said north-south cables are coupled to poles which are coupled to said solar power concentrators.

28. A solar power concentrator, comprising:
lightweight cones with reflective inside surfaces for accepting sunrays at conical wide ends and for concentrating the sunrays by reflection to conical narrow ends;
light-absorbing members that absorb the sunrays to heat fluid within interior or exterior channels of the light-absorbing members, the light-absorbing members being attached to or disposed near the conical narrow ends;
transparent windows attached to or disposed near the conical wide ends;
target rods coated with a solar-energy-absorbing coating, the target rods being disposed inside the light-absorbing members;
fluid passages within the target rods for removing heat from the target rods;
insulating windows attached to or disposed near the light-absorbing members to decrease convective heat loss from the target rods;
a base structure for supporting the light-absorbing members and the target rods; and
an enclosure attached to an outer periphery of the base structure for maintaining air pressure within the solar power concentrator, the air pressure being above atmospheric pressure, the pressurized enclosure providing rigidity to the solar power concentrator, the transparent windows applying tension to the cones to maintain the shape of the cones due to the interior pressure.

29. The solar power concentrator of claim 28, further comprising diagonal wires connected to the base structure and connected to a top periphery of the enclosure, the diagonal wires also providing rigidity to the solar power concentrator.

30. The solar power concentrator of claim 28, further comprising a pivot for movably supporting the base structure, and further comprising a support for supporting the pivot.

31. A solar power concentrator, comprising:
a target rod extending from a base, the target rod coated with a solar-energy-absorbing coating that is designed to limit radiative heat loss;
a flexible housing extending from the base, the flexible housing engaging at least one rigid ring;
a transparent window adjacent to an upper end of the flexible housing; and
at least one fluid passage within the target rod for removing heat from the target rod;
wherein the transparent window applies tension to the flexible housing due to interior air pressure to maintain a shape of the flexible housing, and wherein sunlight is concentrated by reflection from surfaces of the flexible housing onto the target rod to heat the target rod.

32. A solar power concentrator, comprising:
a rigid rod extending from an end of a target rod to a point above an upper opening of a cone reflector;
a transparent window attached to the upper end of the rigid rod and extending to a rigid ring to which the cone reflector is attached;
a flexible housing attached to the rigid ring and extending to and attached to a base structure; and
one or more interior diagonal wires connected to the rigid ring and to the base structure;
wherein the target rod and the rigid rod provide support for the transparent window, which supports the rigid ring, which provides tension to the reflective cone to hold it in conical shape and provides tension to the flexible housing to maintain its shape and wherein the interior diagonal wires help maintain rigidity of the concentrator.

33. A solar power concentrator, comprising:
a plurality of cones with reflective inside surfaces for accepting sunrays at conical wide ends and for concentrating the sunrays by reflection to conical narrow ends;
a target rod located in each of the plurality of cones, the target rod coated with a solar-energy-absorbing coating that is designed to limit radiative heat loss and including at least one fluid passage for removing heat from the target rod;
an enclosure supporting each of the plurality of cones, the enclosure having a base and a support rod extending from the enclosure and engaging a tracking wire;
at least one support member extending from the base of the enclosure and to a mounting structure, wherein the support members pivot to move the plurality of cones; and
a tracking mechanism for tracking the sunrays and moving the enclosures along the tracking wire toward the sunrays.

34. The solar power concentrator of claim 33 wherein the mounting structure is a hollow pipe that conducts a fluid to and from the target rod in the cone.
